(19) United States
(12) Patent Application Publication
(10) Pub. No.: US 2019/0359291 A1
(43) Pub. Date: Nov. 28, 2019

(54) IMPROVED UNDERWATER CONNECTOR

(71) Applicant: Flintstone Technology Limited, Dundee (GB)

(72) Inventor: David SMITH, Dundee (GB)

(21) Appl. No.: 16/477,717

(22) PCT Filed: Jan. 12, 2018
(86) PCT No.: PCT/GB2018/050083

§ 371 Date: Jul. 12, 2019

(30) Foreign Application Priority Data
Jan. 17, 2017 (GB) 1700813.7

(51) Int. Cl. B63B 21/20; F16G 11/00; B63B 21/50

(52) U.S. Cl. CPC B63B 21/20; B63B 21/50; F16G 11/00

(57) ABSTRACT

There is disclosed a connector (100), such as an underwater, offshore or subsea connector, comprising: a first arrangement (15) for connecting a line (140), such as a mooring line, to a structure (145); and a second arrangement (20) for tensioning the line (140). The connection arrangement (15) comprises means for releasably connecting. The connection means (15) comprises a first part (105) and a second part (110) and means for connecting the first and second parts (105; 110). The means for connecting comprise at least part of a recess or bore (or through-passage or through bore) in the second part (110).

### FIELD OF INVENTION

The present invention relates to a connector, such as a mooring/underwater/subsea connector, e.g. for connecting a line or lines, such as mooring lines, to a structure, e.g. a buoyant or semi-buoyant or underwater/subsea structure, such as a submerged turret loading or a submerged turret production buoy. The invention also relates to associated apparatus, structures and methods.

The invention particularly, though not exclusively, relates to a connector providing a tensioning arrangement or means, e.g. means for tensioning a line attached to the connector.

### BACKGROUND TO INVENTION

Mooring lines, e.g. wire, chain or synthetic mooring lines (such as polyester lines) used subsea, for example, in the oil, gas, offshore wind, or tidal energy industries, can be attached to subsea structures by means of a connector. The mooring of such structures may be permanent. However, corrosion of the wires or lines used for mooring may require the replacement of the corroded lines or wires. When such structures are deployed beyond a depth where it is commercially acceptable to use a diver, then such connection may need to be established using a remotely operated vehicle (ROV), which may be used to both connect and disconnect such lines.

Even when not operating beyond a diver depth, better connectors for use with ROVs may be desired, since many operators choose not to use divers, even where practical. There remains a need for a new, simple, robust and easy to use connector.

Further, offshore structures, such as floating structures or floating platforms, can be moored by mooring lines. This can include attaching the mooring lines to the structure to be moored and applying a pre-determined tension to each of the mooring lines. The necessary tension can be applied to the mooring lines, e.g. by using winches that may be provided on the structure to be moored. Such winches can be costly and may only be used intermittently, e.g. during the initial mooring of the structure, relocation of the structure and in response to changing conditions at the mooring site. The installation of a winch on each structure to be moored can become cost and/or time intensive.

A coupling apparatus may be used for connecting the mooring lines from the structure to a seabed. The apparatus may include a guide that can direct a free end of a mooring line towards a surface to enable adjustment of the tension in the mooring lines, e.g. by a winch located on a vessel. During tensioning of the mooring line, bending strain can act on the mooring line due it being pulled and bent around the guide of the apparatus. This can lead to increased wear and/or damages of the mooring line and/or apparatus. In order to minimise the strain on the mooring line, the size of the coupling apparatus may be increased to accommodate larger angles for guiding the mooring line towards the surface. However, this can lead to an increased costs and weight of the coupling apparatus.

Drag Embedment Anchors (DEA) are relatively inexpensive compared to suction piles—though DEA's can be relatively expensive to install. The Inventor has found that installing a tensioner at the seabed may be difficult when utilising DEA's.

This background serves only to set a scene to allow a skilled reader to better appreciate the following disclosure and description. Therefore, none of the above discussion should necessarily be taken as an acknowledgement such that discussion is part of the state of the art or is common general knowledge. One or more aspects/embodiments of the present invention may address one or more of the background issues.

It is an object of at least one embodiment of at least one aspect of the present invention to obviate or at least mitigate at least one or more problems or disadvantages in the prior art.

It is an object of at least one embodiment of at least one aspect of the present invention to provide a combined or integrated connector and tensioner.

It is an object of at least one embodiment of at least one aspect of the present invention to provide a mooring system utilising a Drag Embedment Anchor.

SUMMARY OF INVENTION

According to a general solution, the present invention provides a combined or integrated mooring connector and tensioner.

According to a first aspect of the present invention there is provided a connector, such as an underwater, offshore or subsea connector, comprising:

a first arrangement or means for connecting a line, such as a mooring line, to a structure; and

a second arrangement or means for tensioning the line.

The means for connecting may comprise means for releasably connecting.

The means for connecting may comprise a first part and a second part and means for connecting the first and second parts.

The means for connecting may comprise at least part of a recess or bore (or through-passage or through bore) in the second part.

The first part may comprise means for connecting the first part to one or more line(s), such as one or mooring line(s), and preferably a mooring line. The means for connecting the first part to one or more line(s) may be configured to allow rotational first movement of at least a part of the first part with respect to one or more line(s) about a transverse axis of at least a portion of the first part.

The second part may comprise means for connecting the second part to a structure. The means for connecting the second part to a structure may be configured to allow rotational movement of the second part with respect to a structure about a transverse axis of the second part.

The transverse axis of the first portion of the first part may be substantially perpendicular to the transverse axis of the second part when the first and second parts are connected.

At least part of the first part may be receivable within the at least part of the through-passage. The through-passage may be capable of receiving a work line or wire.

The connector may further comprise means for aligning the first part and the second part with respect to one another, e.g. when mated together.

The means for aligning the first and second parts may comprise first and second means carried by or provided on the first and second parts, respectively. The first and second alignment means may co-act, in use, when the first and second parts are brought together. The first alignment means may comprise at least one first protrusion. The second alignment means may comprise at least one second protrusion.

The means for connecting the first part to one or more lines may comprise one or more first bearing means. The means for connecting the second part to the underwater structure may comprise one or more second bearing means.

The one or more first bearing means may comprise a clevis arrangement.

The one or more second bearing means may comprise one or more protrusions or trunnions.

The transverse axis of the first portion of the first part may be arranged to be offset, such as offset in a longitudinal direction of the first portion or part and/or the second part, from the transverse axis of the second portion. Alternatively, the transverse axis of the first part and/or portion may be arranged to coincide with the transverse axis of the second part, e.g. when the first and second parts are connected.

The first part, e.g. the first portion of the first part, may comprise a male part. The second part may comprise a female part.

In use, insertion of the male part into the female part may cause relative rotational movement of the male part into a pre-selected rotational disposition in the female part. The first part may be inserted into the second part in an at least partly upwards direction. The first part may be insertable or inserted into an at least partly lower facing orifice or opening of the second part.

The rotational movement of the first part may align the transverse axis of the first part relative to the transverse axis of the second part so that the transverse axis of the first part or first portion of the first part is substantially perpendicular to the transverse axis of the second part.

The means for connecting the first part to one or more lines may be configured to allow rotational movement of the first part with respect to one or more lines, and may comprise at least one first degree of freedom. The means for connecting the second part to a structure may be configured to allow rotational movement of the second part relative to a structure and may comprise at least one second degree of freedom.

In use, connection of the first part to the second part may allow movement of one or more lines relative to a structure with two or more degrees of freedom and/or in two or more directions.

The first part may comprise at least part of a means for releasably connecting to the work line or wire.

The part of the line connection means may be configured for releasably engaging with another part of the line connection means of a work wire. Engagement between the at least part of the line connection means and a work line may be caused by tension created between a work line or wire and the first portion.

The male part may comprise an open recess or slot on a free end thereof.

The part of the line connection means may be located or disposed within the open recess or slot of the male part.

The means for connecting the first part and the second part may comprise at least one of:

means for releasably connecting the first part and the second part;

a first aperture in the first (male) part;

at least one second aperture in the second (female) part; and

a pin, receivable, e.g. removably receivable, within the first and second apertures when such are aligned.

The first and/or second apertures may be configured to provide at least one of:

a clearance or space between the pin and the first aperture and/or second aperture during insertion of the pin; and

a contact area between the pin and the first aperture and/or second apertures when the first part is connected to the second part.

The first and/or second apertures may define or provide a profile or cross-section. The profile of the first and/or second aperture may comprise at least one of:

a load bearing surface or portion, which may substantially match or complement a profile or shape of the pin and/or a load bearing surface or part of the pin; and

a non-load bearing surface or portion, which may provide clearance around the pin during insertion.

The means for tensioning may comprise:

a/the first portion for connecting or coupling the first part to the second part;

a second portion for receiving a portion of a/the line, such as a mooring line, extending from below or from underwater;

a guide portion for guiding a/the portion of a line received by the second portion, the guide portion being movably connected to the second portion.

the first portion being movably connected to the second portion and/or the guide portion.

The tensioning means may comprise an axis, and the first portion, the second portion and/or the guide portion may be arranged to be moveable around or about the axis of the tensioning means.

The tensioning means may comprise a line engaging device. The line engaging device may be movably connected or connectable to the second portion

The apparatus may comprise a line engaging device, the line engaging device may be movably connected or connectable to the first part, e.g. the second portion of the first part, e.g. between open and closed/locked/latched positions.

The line engaging device may be configured to be moveable, operable and/or actuatable from the second position to the first position, when tension is released from at least one end of a line received in or threaded through the apparatus.

The tensioning means may be operable, moveable or actuatable between a first configuration in which the line engaging device is in the first position, and a second configuration in which the line engaging device is in the second position.

In the first configuration, the first and second portions may be arranged relative to each other such that a longitudinal axis of the second portion is substantially in line, collinear or coaxial with a longitudinal axis of the first portion.

The tensioning means may be configured or arranged such that in the first configuration a/the longitudinal axis of the tensioning means may be substantially in line, collinear or coaxial with a longitudinal axis of a portion of a line extending from underwater.

The tensioning means may be configured or arranged such that in the first configuration the axis is substantially co-planar with a longitudinal axis of a line extending from underwater, and/or the axis extends in a direction substantially perpendicular to a longitudinal axis of a line extending from underwater.

In the second configuration, the first and second portions may be arranged relative to each other such that a/the longitudinal axis of the second portion extends at an angle relative to a/the longitudinal axis of the first portion.

The guide portion may be connected to the second portion such that the axis extends in a direction substantially perpendicular to a/the longitudinal axis of the second portion and/or that a/the longitudinal axis of the first portion intersects the axis.

The second portion may be configured to receive, mount and/or support a mounting element connected to at least one end of a line.

The first portion may be configured to align a mounting element connected to at least one end of a line received in or threaded through the connector, and/or at least one end of a line received in or threaded through the connector relative to the connector.

The first portion may comprise a groove and/or a protrusion, the groove and/or protrusion being shaped for mounting and/or supporting a mounting element connected to at least one end of a line received in or threaded through the tensioning means to or on the tensioning means.

The first portion may comprise a first connector portion for complementary mating with a corresponding second connector portion, e.g. of the second part.

The first connector portion may be moveably connected or connectable to the second connector portion.

The second connector portion may be configured to connect the apparatus to a/the structure.

Advantageously the transverse axis of the first portion of the first part may be substantially perpendicular to an axis of rotation of the guide portion.

According to a second aspect of the present invention there is provided a mooring system comprising:

a structure to be moored;

at least one mooring line;

a first (upper) end of the mooring line being connected to the structure to be moored by a connector according to the first aspect of the present invention; and

a second (lower) end of the mooring line being connected to an anchoring means.

Beneficially, the anchoring means may be a Drag Embedment Anchor. Alternatively, the anchoring means may be a suction pile.

The structure may be a buoyant or semi-buoyant structure, buoy, e.g. a turret buoy, floating structure, offshore structure, or floating platform buoy. Alternatively, the structure may be a vessel, e.g. ship or boat.

The at least one mooring line may comprise chain, wire and/or rope.

According to a third aspect of the present invention there is provided a method of connecting and tensioning a line to a structure, the method comprising:

providing a structure to be moored, a line to be attached to the structure, and a connector according to the first aspect of the present invention;

connecting the line to the structure by the connector; and

tensioning the line to the structure by the connector.

### BRIEF DESCRIPTION OF DRAWINGS

An embodiment of the present invention will now be described by way of example only, with reference to the accompanying drawings, which are:

FIG. 1 a schematic view of subsea mooring lines connected to a turret buoy by connectors according to an embodiment of the present invention, the turret buoy being connected or moored to a vessel;

FIGS. 2(a) to (c) perspective, end, and side views, respectively, of a connector according to the present invention connected to a turret buoy;

FIG. 3 a schematic view of a connector (subsea connector), according to an embodiment of the present invention;

FIG. 4 a schematic view of a first part of the connector of FIG. 3;

FIG. 5 a schematic view of a second part and second bearing means of the connector of FIG. 3;

FIG. 6(a) a schematic view of alignment means of the connector of FIG. 3;

FIG. 6(b) a schematic view of the first part and the second part or the connector of FIG. 3 connected together;

FIG. 7 a schematic view of a second part of the connector of FIG. 3 with a work wire run through a bore thereof;

FIG. 8 a schematic view of the second part of the connector of FIG. 3 connected to a structure with a temporary sheave member installed;

FIG. 9 a schematic view of the connector of FIG. 3 with the first part being pulled towards the second part;

FIG. 10 a schematic view of the connector of FIG. 3 with the first part received by and within the second part;

FIG. 11 a schematic view of the connector of FIG. 3 with a pin received within the subsea connector;

FIG. 12 a schematic view of an inter-engaging coupling arrangement for locking the pin to the connector of FIG. 3;

FIG. 13 a schematic view of the connector of FIG. 3 connected to a structure and removal of the temporary sheave member; and

FIG. 14 a schematic view of the connector of FIG. 3 and disengagement of the work wire.

### DETAILED DESCRIPTION OF DRAWINGS

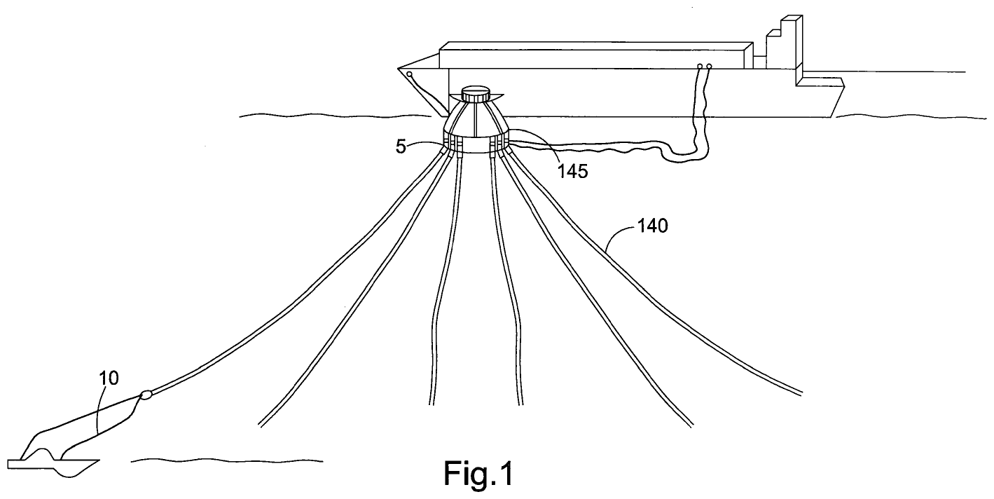

Referring initially to FIG. 1, the present invention provides a mooring system 5 comprising:

a structure (mooring buoy) 145 to be moored;

at least one mooring line 140;

a first (upper) end of the/each mooring line 140 being connected to the structure 145 to be moored by a connector 100 according to an embodiment of the present invention; and

a second (lower) end of the/each mooring line 140 being connected to an anchoring means 10.

In this embodiment, the anchoring means 10 comprises a Drag Embedment Anchor. Alternatively, the anchoring means can be a suction pile.

The structure is typically a buoyant or semi-buoyant structure, e.g. a mooring buoy, a turret buoy, floating structure, an offshore structure, a floating platform buoy, or a vessel, e.g. ship or boat. It will, however, be appreciated that other structures may be envisaged.

The at least one mooring line 140 comprises chain, wire and/or rope.

The connector 100 according to the invention comprises a combined or integrated mooring connector and tensioner.

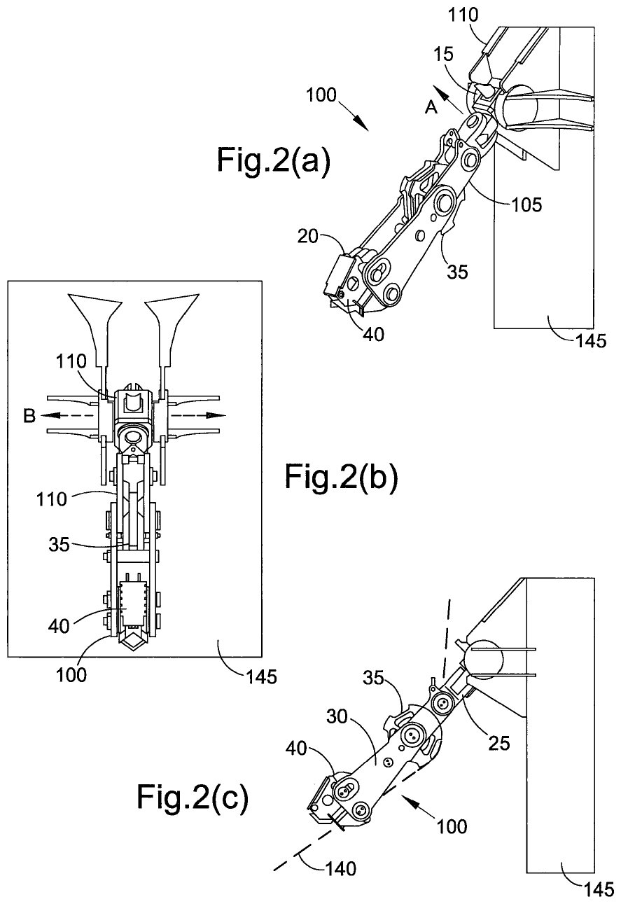

Referring to FIGS. 2(a) to (c), the connector 100—such as an underwater, offshore or subsea connector—comprises:

a first arrangement or means 15 for connecting a line 140 to the structure 145; and

a second arrangement or means 20 for tensioning the line 140.

The means for connecting 15 comprise a first part 105 and a second part 110 and means for connecting the first and second parts 105, 110. The means for connecting 15 comprise at least part of a through-passage or bore in the second part 110.

The first part 105 comprises means for connecting the first part to one or more line(s) 140, such as one or more mooring line(s), and in this embodiment, a mooring line. The means 15 for connecting the first part 105 to one or more line(s) 140 is configured to allow rotational first movement of at least a part of the first part 105 with respect to one or more line(s) 140 about a transverse axis A of at least a portion of the first part 105.

The second part 110 comprises means for connecting the second part 110 to a structure 145. The means for connecting the second part 110 to a structure 145 are configured to allow rotational movement of the second part 110 with respect to a structure 145 about a transverse axis B of the second part 110.

The transverse axis A of the first part 105 is substantially perpendicular to the transverse axis B of the second part 110 when the first and second parts 105, 110 are connected.

At least part of the first part 105 is receivable within the at least part of the through-passage. The through-passage is capable of receiving a work line or wire.

The connector 100 further comprises means for aligning the first part 105 and the second part 110 with respect to one another. The means for aligning the first and second parts 105, 110 comprise first and second means carried by or provided on the first and second parts 105, 110, respectively. The first and second alignment means co-act, in use, when the first and second parts are brought together. The first alignment means comprise at least one first protrusion. The second alignment means comprises at least one second protrusion.

The means for connecting the first part 105 to one or more lines 140 comprise one or more first bearing means. The means for connecting the second part 110 to the structure 140 comprises one or more second bearing means. The one or more first bearing means can comprise a clevis arrangement. The one or more second bearing means can comprise one or more protrusions or trunnions.

The transverse axis A of the first portion of the first part 105 is arranged to be offset, such as offset in a longitudinal direction of the first portion or part and/or second part, from the transverse axis B of the second portion 110. Alternatively, the transverse axis A of the first part 105 and/or portion can arranged to coincide with the transverse axis B of the second part 110, e.g. when the first and second parts are connected.

Typically, the first part 105 comprises a male part, the second part 110 comprises a female part. In use, insertion of the male part into the female part causes rotational movement of the male part into a pre-selected rotational disposition in the female part. The first part 105 is inserted into the second part 110 in an at least partly upwards direction. The first part 105 is insertable or inserted into an at least partly lower facing orifice or opening of the second part 110.

The rotational movement of the first part 105 aligns the transverse axis A of the first part 105 relative to the transverse axis B of the second part so that the transverse axis A of the first part 105 or first portion of the first part 105 is substantially perpendicular to the transverse axis B of the second part 110.

The means for connecting the first part 105 to one or more lines can be configured to allow rotational movement of the first part 105 with respect to one or more lines and can comprise at least one first degree of freedom. The means for connecting the second part 110 to a structure 145 can be configured to allow rotational movement of the second part 110 relative to a structure and can comprise at least one second degree of freedom.

In use, connection of the first part 105 to the second part 110 can allow movement of one or more lines 140 relative to a structure 145 with two or more degrees of freedom and/or in two or more directions.

The first part 105 can comprise at least part of a means for releasably connecting to the work line or wire. The part of the line connection means can be configured for releasably engaging with another part of the line connection means of a work wire. Engagement between the at least part of the line connection means and a work line is caused by tension created between a work line or wire and the first portion 25.

The male part can comprise an open recess or slot on a free end thereof. The part of the line connection means can be located or disposed within the open recess or slot of the male part. The means for connecting the first part 105 and the second part 110 can comprise at least one of:

means for releasably connecting the first part 105 and the second part 110;

a first aperture in the first (male) part 105;

at least one second aperture in the second (female) part 110; and a means for connecting 115, i.e. pin 260, the first and second parts 105, 110, the means for connecting 115 being receivable, e.g. removably receivable, within the first and second apertures when such are aligned.

The first and/or second apertures can be configured to provide at least one of:

a clearance or space between the pin and the first aperture and/or second aperture during insertion of the pin 260; and

a contact area between the pin 260 and the first aperture and/or second apertures when the first part 105 is connected to the second part 110.

The first and/or second apertures can define or provide a profile or cross-section. The profile of the first and/or second aperture can comprise at least one of:

a load bearing surface or portion, which can substantially match or complement a profile or shape of the pin 260 and/or a load bearing surface or part of the pin 260; and

a non-load bearing surface or portion, which can provide clearance around the pin 260 during insertion.

In this embodiment the means for tensioning 20 comprise:

a/the first portion 25 for connecting or coupling the first part 105 to the second part 110;

a second portion 30 for receiving a portion of the line 140, such as a mooring line, extending from below/underwater;

a guide portion 35 for guiding a/the portion of a line 140 received by the second portion 30, the guide portion 35 being movably (rotatably) connected to the second portion 30;

the first portion 25 being movably connected to the second portion 30 and/or the guide portion 35.

The tensioning means 20 comprises an axis A, and the first portion 25, the second portion 30 and/or the guide portion 35 arranged to be moveable around or about the axis of the tensioning means 20.

The tensioning means 20 comprises a line engaging device 40. The line engaging device 40 is movably connected or connectable to the second portion 30.

The apparatus comprises a line engaging device. The line engaging device 40 is movably connected or connectable to the first part 105, e.g. the second portion 30 of the first part 105, e.g. between open and closed/locked/latched positions.

The line engaging device 40 is configured to be moveable, operable and/or actuatable from the second position to the first position, when tension is released from at least one end of a line 140 received in or threaded through the apparatus or connector 100.

The tensioning means 20 is operable, moveable or actuatable between a first configuration in which the line engaging device 40 is in the first position, and a second configuration in which the line engaging device 40 is in the second position.

In the first configuration, the first and second portions 25, 30 are arranged relative to each other such that a longitudinal axis of the second portion 30 is substantially in line, collinear or coaxial with a longitudinal axis of the first portion 25.

The tensioning means 20 are configured or arranged such that in the first configuration a/the longitudinal axis of the tensioning means 20 are substantially in line, collinear or coaxial with a longitudinal axis of a portion of a line 140 extending from underwater.

The tensioning means 20 are configured or arranged such that in the first configuration the axis is substantially co-planar with a longitudinal axis of a line 140 extending from underwater, and/or the axis extends in a direction substantially perpendicular to a longitudinal axis of a line 140 extending from underwater.

In the second configuration, the first and second portions 25, 30 are arranged relative to each other such that a/the longitudinal axis of the second portion 30 extends at an angle relative to a/the longitudinal axis of the first portion 25.

The guide portion 35 is connected to the second portion 30 such that the axis extends in a direction substantially perpendicular to a/the longitudinal axis of the second portion 30 and/or that a/the longitudinal axis of the first portion 25 intersects the axis. The second portion 30 is configured to receive, mount and/or support a mounting element connected to at least one end of a line 140.

The first portion 25 is configured to align a mounting element connected to at least one end of a line received in or threaded through the connector 100, and/or at least one end of a line received in or threaded through the connector 100 relative to the connector 100.

The first portion 25 comprises a groove and/or a protrusion, the groove and/or protrusion being shaped for mounting and/or supporting a mounting element connected to at least one end of a line received in or threaded through the tensioning means 20 to or on the tensioning means 20.

The first portion 25 comprises a first connector portion for complementary mating with a corresponding second connector portion, e.g. of the second part. The first connector portion is moveably connected or connectable to the second connector portion. The second connector portion can be configured to connect the apparatus to a structure 145.

Advantageously the transverse axis of the first portion 25 of the first part 105 is substantially perpendicular to an axis of rotation of the guide portion 35.

Referring again to FIG. 1, there is shown a structure 145, e.g. a subsea structure, such as a submerged turret loading or a submerged turret production buoy, which in this Figure is shown connected to a vessel. It will be appreciated that the term “submerged” can include both fully submerged (e.g. entirely beneath a waterline) as well as partially submerged (e.g. partially beneath a waterline). As is shown in FIG. 1, the subsea structure 145 is moored to the seabed by one or more mooring lines 140.

Referring to FIGS. 2 to 7, there is shown a (subsea) connector, generally designated 100, according to an embodiment of the present invention. Such a connector 100 can be used for connecting the structure 145 to one or more mooring lines 140. Here, the connector 100 comprises a first part 105 and a second part 110. In this example, the first part 105 may be considered to be a male part, while the second part 110 may be considered to be a female part. The connector 100 further comprises means 115 for connecting the first and second parts 105, 110, which comprises at least part of a through-passage 120 in the second part 110, as will be explained. The means 115 for connecting advantageously comprises means 115 for releasably connecting.

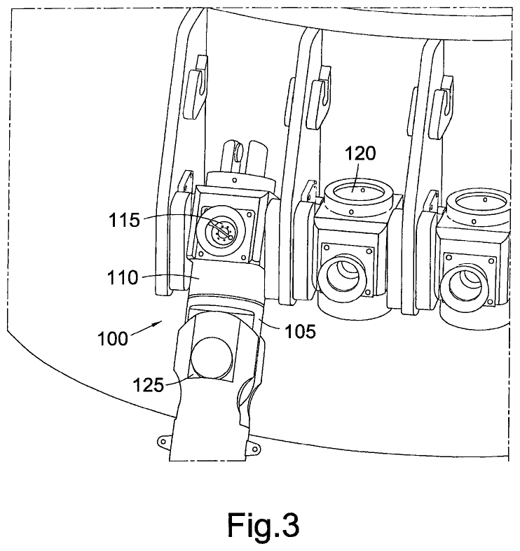

Referring to FIG. 3, there is shown the first part 105 of a (subsea) connector 100 configured for connection to the second part 110 of the connector 100 by means for pulling 200 (see FIG. 7) the first part 105 into the second part 110. The means for pulling 200 are capable of pulling or moving the first part 105 into alignment within the second part 110. Of course, in other embodiments, the second part 110 of a subsea connector 100 can be configured for connection to the first part 105 of the subsea connector 100 by means for pulling 200 the second part 110 into the first part 105, where the means for pulling can be capable of pulling or moving the second part into alignment within the first portion.

Here, at least part of the first part 105 is receivable within the at least part of the through-passage 120. Further, the through-passage 120 is capable of receiving (for example threadably receiving) a work line 155 or wire, as will be described, and as is shown in FIG. 5.

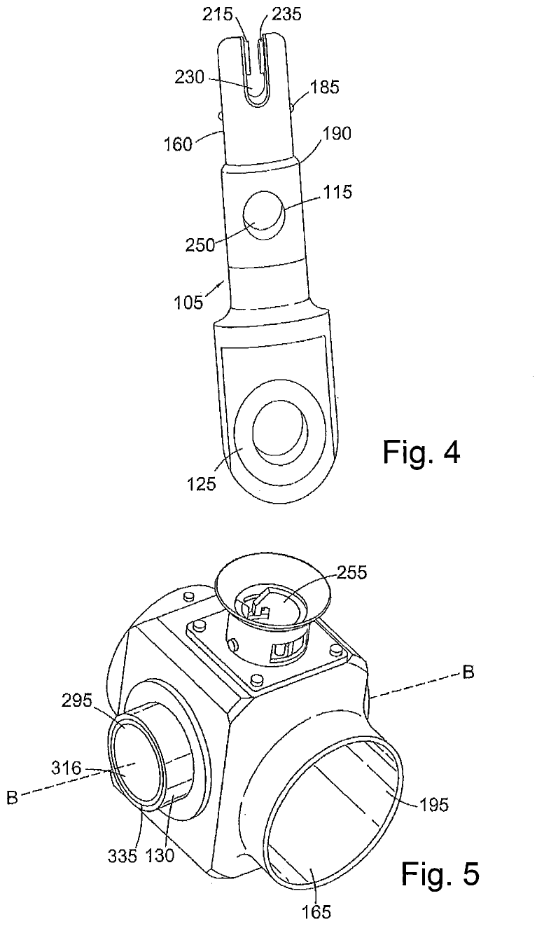

The first part 105 of the connector 100 further comprises means 125 for connecting to one or more lines 140, such as mooring lines, whereas the second part 110 comprises means 130 for connecting to the subsea structure 145 (e.g. see FIG. 4).

The means 125 for connecting the first part 105 to one or more lines 140 allow rotational movement about a transverse axis A of the first part 105. The means for connecting the first part 105 to one or more lines 140 defines or allows movement, e.g. rotational movement, of the first part 105 with respect to one or more lines 140, comprising at least one first degree of freedom.

In some examples, the means 125 for connecting the first part 105 to one or more lines 140 can provide a joint or connection, which comprises at least one first degree of freedom of rotational movement. In some embodiments, the first part 105 can be connected to one or more lines 140 by one or more first bearing means or arrangement 290, which are provided by the first part 105. In this embodiment, the first bearing means 290 includes a clevis arrangement 350 or the like. The transverse axis A of the first part 105 can be provided by a clevis pin or bolt 360. The clevis arrangement 350 allows rotational movement between the line 140 and the first part 105 about the clevis pin 360.

The second part 110 is connected to a structure 145 so as to allow rotational movement of the second part 110 with respect to a subsea structure 145. The rotational movement of the second part 110 is about a transverse axis B of the second part 110, which is perpendicular to a longitudinal axis (not shown) of the second part 110. The means 130 for connecting the second part 110 to a subsea structure 145 allow for rotational movement of the second part about the transverse axis of the second part 110, which is in this embodiment a substantially horizontal axis B. By connecting the second part 110 to a subsea structure so as to allow rotational movement about the transverse axis B of the second part 110, fabrication of the means 130 for connecting the second part 110 to a (subsea) structure can be facilitated. By allowing rotational movement of the second part 110 about the transverse axis B, weight of the means 130 connecting the second portion to a structure and/or connector 100 can be reduced.

In this example, the second part 110 is connected to a structure 145 by one or more second bearing means or arrangement 295, which can be carried by the second part 110. The second bearing means 295 comprise one or more trunnions 316. The second bearing means 295 provide rotational movement about the transverse axis B of the second part 110 with respect to the subsea structure. By allowing rotational movement of the second part 110 about the transverse axis B thereof, loads and/or stresses, for example, in a longitudinal direction or axis of the second part 110—which may act on the connector 100, second part 110 and/or a subsea structure 145, can be reduced when the second part 110 is connected to the first part 105, in use.

As can be seen in FIGS. 3, 10 and 11, the transverse axis A of the first part 105 is substantially perpendicular to the transverse axis B of the second part 110, in use, when the first 105 and second 110 parts are connected. In this embodiment, the transverse axis A of the first part 105 is provided offset in a longitudinal direction of connector 100 from the transverse axis B of the second part 110 so that there is a space or distance between the transverse axis A of the first part 105 and the transverse axis B of the second part 110. The connector 100 in this embodiment has an extended universal-joint arrangement.

The means 130 for connecting the second part 110 to a subsea structure 145 defines or allows movement, e.g. rotational movement, of the second part 110 relative to a subsea structure 145, comprising at least one second degree of freedom.

In some examples, the means 130 for connecting the second part 110 to a structure 145 provide a further joint or connection, which has at least one second degree of freedom of rotational movement. In use, connection of the first part 105 to the second part 110 allows rotational movement with two or more degrees of freedom of one or more lines relative to a subsea structure 145. When connected, the first and second connection means allow for movement of the one or more lines 140 relative to the subsea structure 145 in two or more planes and/or directions.

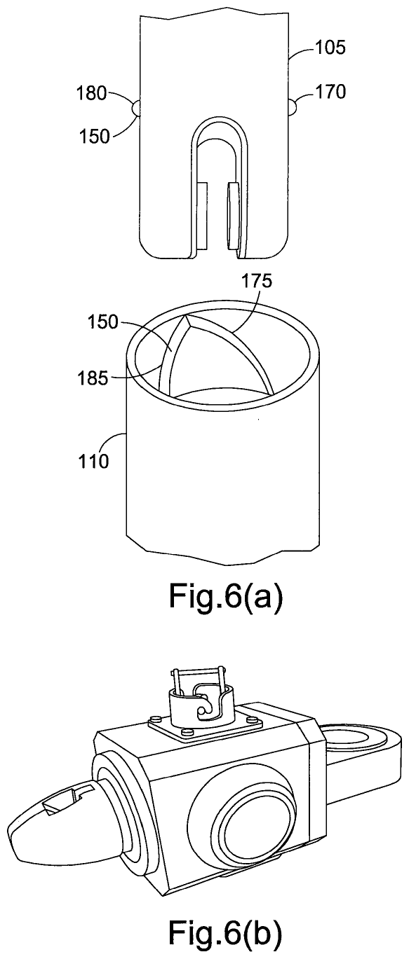

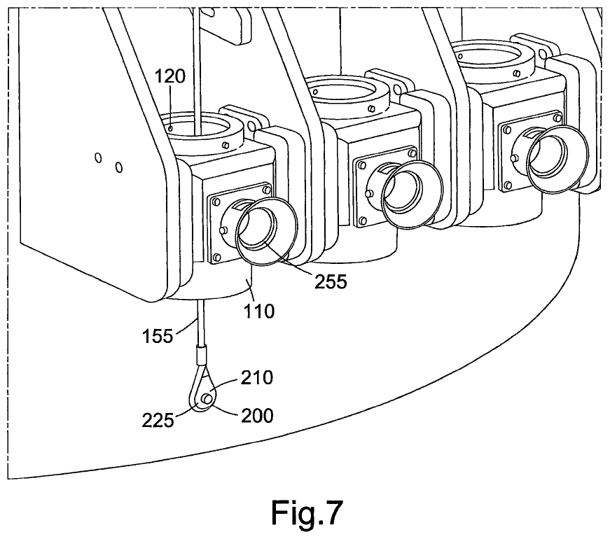

As is shown in FIG. 6, for example, the connector 100 additionally comprises means 150 for aligning, e.g. self-aligning the first part 105 and the second part 110 with respect to one another. When brought together so as to be connected, the means 150 for aligning on both the first part 105 and second part 110 interoperate with one another so as to orientate the first part 110 in a particular configuration with respect to the second part 120. As is shown on FIG. 6, the means 150 for aligning the first and second parts 105, 110 comprise first and second means 170, 175 carried by or provided on the first and second parts 105, 110, respectively. Those first and second alignments means 170, 175 co-act, in use, when the first and second parts 105, 110 are brought together. Here, the first alignment means 170 comprises at least one first protrusion 180, and the second alignment means 175 comprises at least one second protrusion 185 also such that the at least one first and second protrusions 180, 185 co-act, in use, and rotate the first and second parts 105, 110 with respect to one another around a longitudinal axis, when the first and second parts 105, 110 are brought together. Of course, in further examples, one or more protrusions and complementary recesses can be provided, as will be appreciated.

As is shown (e.g. in FIG. 4), a male part 160 of the first part 105 comprises a cylindrical portion 190, whereas the at least part of the through-passage 120 is a cylindrical bore 195 e.g. an open bore (see FIG. 4), such that the female part comprises the through-passage 120, within which the male part 160 or cylindrical portion 190 is received. The male part 160 can be received in a substantially tight or snug fit.

In this example, the first part 105 also comprises means 205 for releasably connecting to a work line 155 or wire. Here, the line connecting means 205 are an inter-engaging coupling arrangement, although alternative configurations will be evident. The inter-engaging coupling arrangement is configured for pulling, or at least moving, the first part 105 of the subsea connector 100 towards the second part 110. The line connecting means 205 comprises first and second line connection means 210, 215, respectively.

In the example shown, the first line connection means 210 is configured for releasably engaging with the second line connection means 215. Alternatively, however, the second line connection means 215 can be configured for releasably engaging with the first line connection means 210. Engagement of the first and second line connection means 210, 215 can be caused by tension created between the work line or wire 155 and the first part 105 of the subsea connector 100.

In this example, the first line connection means 210 is provided by, or carried on, a free end of the line or wire 155, and comprises a first and second protrusion 220 (shown as pins 221, 222) disposed on opposite sides of a plate member or attachment member 225 of the wire or line.

The male part 160 of the first part 105 comprises an open recess or slot 230 on a free end thereof, and the second line connection 215 means can be located or disposed within the open recess or slot 230 of that male part 160.

The second line connection means 215 also comprises a first and second retaining member 235, which are disposed on opposite sides, opposing each other, of the width of the open recess or slot 230. The first and second retaining members 235 comprise a further opening or recess 240 adapted for receiving the first and second pins 221, 222 of the first line connection means 210. Here, the opening or recess 240 of the first and second retaining members 235 is adapted to face opposite to that of the male part 160, e.g. in a downward direction with respect to the first portion 105. In other words, the opening or recess 240 faces inwardly towards the body of the first portion. In alternative embodiments, the second line connection means 215 can comprise an elongate member or bar spanning the width of the open recess or slot 230. In further alternative embodiments, the first line connection means 210 can comprise a member for connecting to the elongate member or bar of the male part 160, such as a hook or the like.

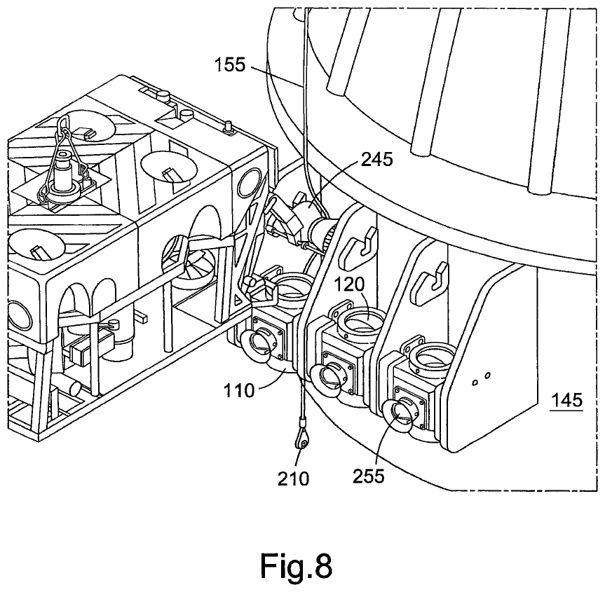

In use (e.g. see FIG. 8), an ROV is able to run the work line or wire 155 through the bore 195 of the female part 165, as shown in FIG. 5. The ROV can then connect the work line or wire 155, comprising the first line connection means 210, to the second line connection means 215 of the male part 160.

With specific reference to FIGS. 7 to 9, engagement between the first and second line connection means 210, 215 can be caused by tension in an upward direction created between the work line or wire 155 and the first part 105 of the subsea connector 100, e.g. the first and second pins 221, 222 co-act or engage with the first and second retaining members 235. Of course, in alternative examples, a hook or the like may engage with an elongate member (not shown).

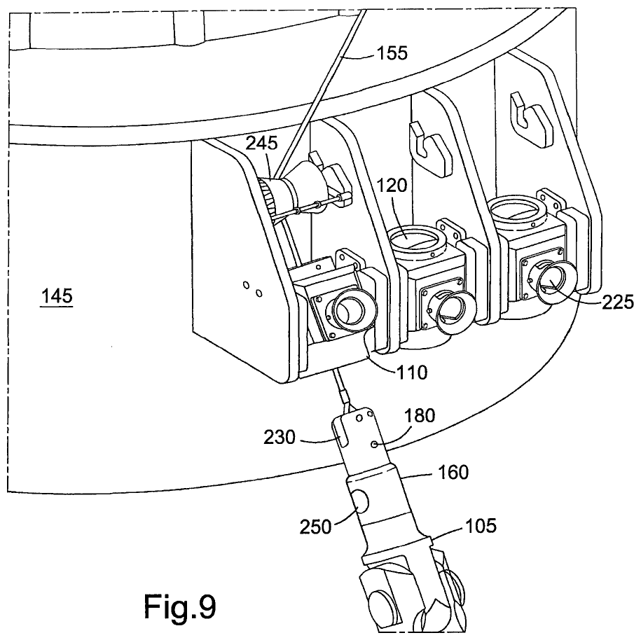

Subsequently, the ROV can pull the male part 160 towards the female part 165 such that the male part 160 is inserted into the female part 165. A temporary sheave member 245 facilitates the pulling of the first part 105 towards the second part 110, as shown in FIG. 9.

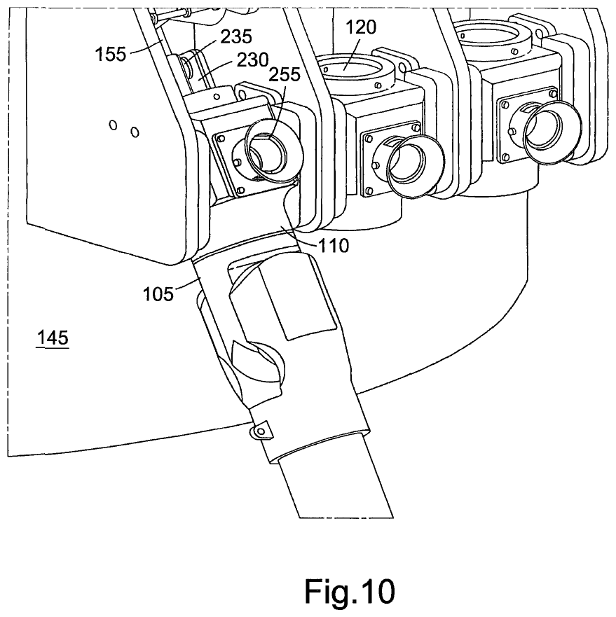

Insertion of the male part 160 into the female part 165 can cause the first alignment means and second alignment means 170, 175 (see FIG. 6) to rotationally co-act, thereby relatively (longitudinally) rotating the male part and the female part into a pre-selected or pre-determined rotational disposition, as shown in FIG. 10.

The means 115 for connecting the first part 105 and the second part 110 comprises a first aperture 250 in the male part 160, e.g. a pair of diametrically or width-wise apertures spanning the cylindrical portion 190 of the male part 160. The means 115 for connecting the first part 105 and the second part 110 comprises at least one second aperture 255, e.g. a pair of diametrically opposed apertures, in the female part 165.

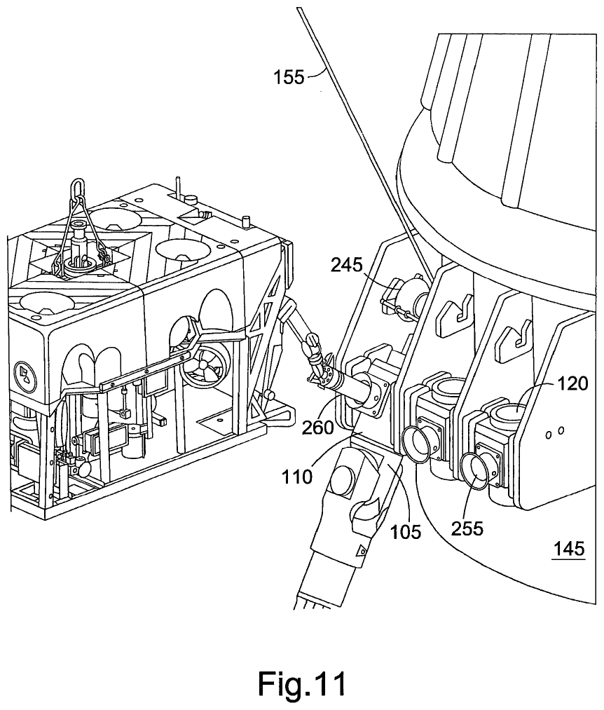

Referring to FIG. 11, the means 115 for connecting the first portion 105 and the second portion 110 comprises a pin 260, e.g. a pin, such as a load bearing pin, removably receivable within the first and second apertures 250, 255 when are aligned, for example, when aligned in a pre-selected rotational disposition. As such, the ROV can mate and/or release the first and second parts 105, 110, e.g. subsea/underwater, and/or to insert and/or remove the pin 260. In the example shown, the pin 260 has a tapered end, which can facilitate ease of insertion thereof into the apertures 250, 255.

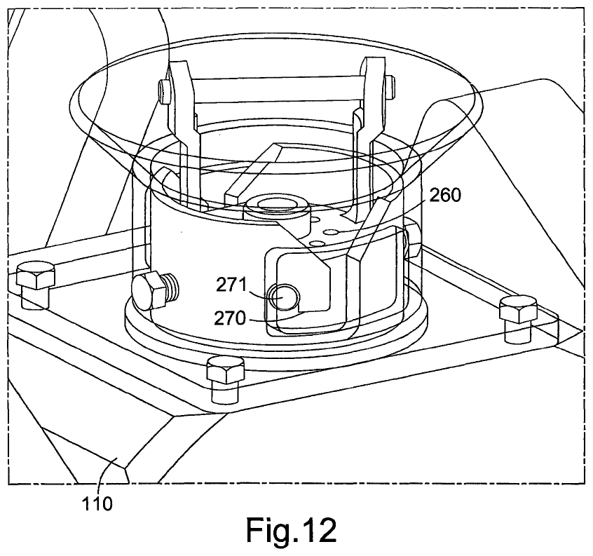

Referring to FIG. 12, the pin 260 comprises a further inter-engaging coupling arrangement 270 configured for locking, or at least retaining, the pin 260 with respect to the subsea connector 100. In this example, the further inter-engaging coupling arrangement 270 comprises a bayonet configuration 271 carried or provided by the pin 260 and the second part 110.

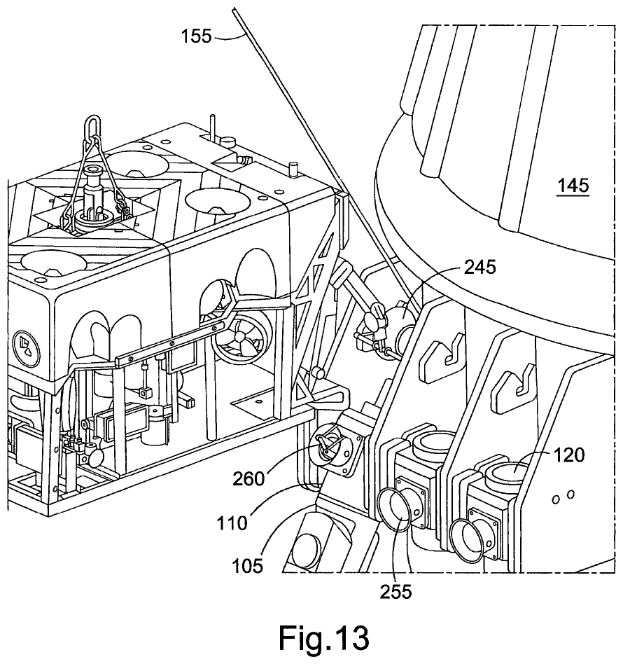

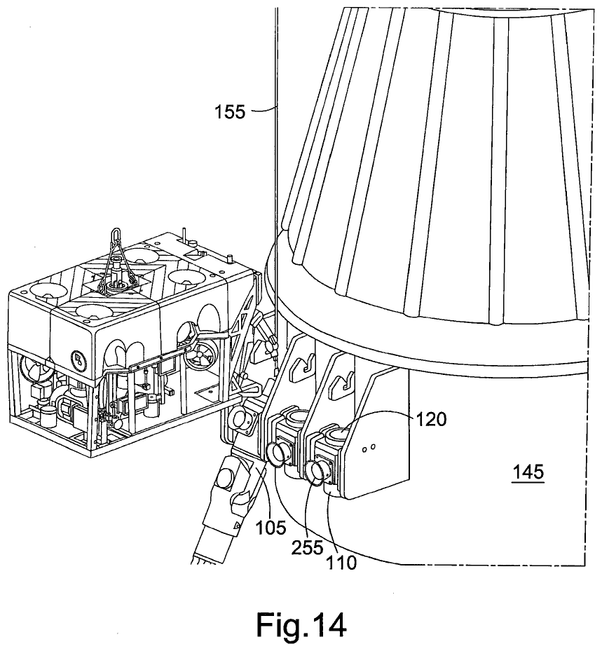

After the pin 260 has been located, and retained, the ROV can remove any temporary sheave member 245, which leads to a reduction in tension of the work line or wire 155, as shown in FIG. 13. The ROV can then disconnect the work line or wire 155 from the male part 160 by disengaging the first line connection means from the second line connection means 210, 215 (e.g. see FIG. 14).

In some examples, the aforementioned first part 105, second part 110 and/or pin 260 are made from a metal or metallic material (e.g. made by forging).

It will be appreciated that with such a connector 100 (or system 245) it may be helpful to permit some relative movement, such as rotation, of any mooring line 140 and connected structure 145. As such, in the embodiment shown, the connection between the first part 105 and the line 140 is adapted so as to allow for such rotational movement around or about a (discrete) transverse axis A (FIG. 7) of the first part 105 with respect to line 140. Further, the connection between the second part 110 and the subsea structure 145 is adapted so as to allow rotational movement around or about a (discrete) transverse axis B (FIG. 4) of the second part 110 with respect to subsea structure 145. In the example described, the (discrete) transverse rotational axis A of the first part 105 can be considered to be substantially perpendicular to the (discrete) transverse rotational axis B of the second part 105. As such, the use of such a connector can obviate the need for any additional rotation coupling in the mooring line, or the like (e.g. no need for an additional uni-joint, or the like).

In use, a method of connecting and tensioning a line to a structure 145 is provided, the method comprising:

providing a structure 145 to be moored, a line 140 to be attached to the structure 145, and a connector 100;

connecting the line 140 to the structure by the connector 100; and

tensioning the line 140 to the structure 145 by the connector 100.

It will be appreciated that the embodiment of the present invention hereinbefore described is given by way of example only, and is not meant to be limiting to the scope of invention in any way. It will also be appreciated that in scenarios where an operator wishes to utilise Drag Embedment Anchors (DEAs), the integrated connector/tensioner of the present invention may provide particular benefit.

1. A combined connector and tensioner, such as an underwater, offshore or subsea mooring connector and tensioner, comprising:
an arrangement for releasably connecting a line, such as a mooring line, to a structure; and
an arrangement for tensioning the line.

2. (canceled)

3. A combined connector and tensioner as claimed in claim 1, wherein the arrangement for releasably connecting comprises a first part and a second part and means for connecting the first and second parts and wherein the arrangement for releasably connecting comprises at least part of a recess or bore or through-passage or through bore in the second part.

4. (canceled)

5. A combined connector and tensioner as claimed in claim 3, wherein the first part comprises means for connecting the first part to one or more line(s), such as one or more mooring line(s), the means for connecting the first part to one or more line(s) optionally being configured to allow a first rotational movement of at least a part of the first part with respect to one or more line(s) about a transverse axis of at least a first portion of the first part,
the second part comprises means for connecting the second part to a structure, the means for connecting the second part to a structure optionally being configured to allow a second rotational movement of the second part with respect to a structure about a transverse axis of the second part; and
the transverse axis of the first portion of the first part is substantially perpendicular to the transverse axis of the second part when the first and second parts are connected.

6-7. (canceled)

8. A combined connector and tensioner as claimed in claim 3, wherein at least part of the first part is receivable within the at least part of the through-passage, optionally the through-passage being capable of receiving a work line or wire.

9. A combined connector and tensioner as claimed in claim 3, wherein the connector further comprises an arrangement for aligning the first part and the second part with respect to one another, such as when mated together,
wherein the arrangement for aligning the first part and the second part comprise first and second alignment means carried by or provided on the first and second parts, respectively, the first and second alignment means co-acting, in use, when the first and second parts are brought together, the first alignment means comprises at least one first protrusion, and/or the second alignment means comprises at least one second protrusion.

10. (canceled)

11. A combined connector and tensioner as claimed in claim 5, wherein the means for connecting the first part to one or more lines comprises one or more first bearing means, and/or the means for connecting the second part to the underwater structure comprise one or more second bearing means,
wherein the one or more first bearing means comprise a clevis arrangement, and/or the one or more second bearing means comprise one or more protrusions or trunnions.

12. (canceled)

13. A combined connector and tensioner as claimed in claim 5, wherein the transverse axis of the first portion of the first part is arranged to be offset, such as offset in a longitudinal direction of the first portion or part and/or the second part, from the transverse axis of the second portion, or the transverse axis of the first part and/or portion is arranged to coincide with the transverse axis of the second part, for example, when the first and second parts are connected.

14. A combined connector and tensioner as claimed in claim 3, wherein the first part, for example, the first portion of the first part comprises a male part, and/or the second part comprises a female part,
wherein, in use, insertion of the male part into the female part causes relative rotational movement of the male part into a pre-selected rotational disposition in the female part, optionally the first part being inserted into the second part in an at least partly upwards direction, and/or the part being insertable or inserted into an at least partly lower facing orifice or opening of the second part, and
wherein the rotational movement of the first part aligns a/the transverse axis of the first part relative to the transverse axis of the second part so that the transverse axis of the first part or first portion of the first part is substantially perpendicular to a/the transverse axis of the second part.

15-17. (canceled)

18. A combined connector and tensioner as claimed in claim 3, wherein, in use, the connection of the first part to the second part allows movement of one or more lines relative to a structure with two or more degrees of freedom and/or in two or more directions.

19. A combined connector and tensioner as claimed in claim 3, wherein the first part comprises at least part of a means for releasably connecting to a work line or wire; and optionally
the part of the work line connection means is configured for releasably engaging with another part of the work line connection means of a work wire, optionally engagement between the at least part of the work line connection means and a work line being caused by tension created between a work line or wire and the first portion.

20. A combined connector and tensioner as claimed in claim 14, wherein the male part comprises an open recess or slot on a free end thereof, and
a part of a work line connection means is disposed within the open recess or slot of the male part.

21. (canceled)

22. A combined connector and tensioner as claimed in claim 3, wherein the means for connecting the first part and the second part comprises at least one of:
means for releasably connecting the first part and the second part;
a first aperture in the first part;
at least one second aperture in the second part; and
a pin, receivable, such as removably receivable, within the first and second apertures when such are aligned.

23-24. (canceled)

25. A combined connector and tensioner as claimed in claim 3, wherein the tensioning arrangement comprises:
a first portion for coupling the first part to the second part;
a second portion for receiving a portion of a mooring line, extending from below or from underwater;
a guide portion for guiding the portion of a line received by the second portion, the guide portion being movably connected to the second portion;
the first portion being movably connected to the second portion and to the guide portion.

26. (canceled)

27. A combined connector and tensioner as claimed in claim 1, wherein the tensioning arrangement comprises a line engaging device.

28-29. (canceled)

30. A combined connector and tensioner as claimed in claim 1, wherein:
the tensioning arrangement is operable, moveable or actuatable between a first configuration in which the line engaging device is in the first position, and a second configuration in which the line engaging device is in the second position; and/or
in the first configuration, the first and second portions are arranged relative to each other such that a longitudinal axis of the second portion is substantially in line, collinear or coaxial with a longitudinal axis of the first portion; and/or
the tensioning arrangement is configured or arranged such that in the first configuration a/the longitudinal axis of the tensioning arrangement is substantially in line, collinear or coaxial with a longitudinal axis of a portion of a line extending from underwater; and/or
the tensioning arrangement is configured or arranged such that in the first configuration the axis is substantially co-planar with a longitudinal axis of a line extending from underwater, and/or the axis extends in a direction substantially perpendicular to a longitudinal axis of a line extending from underwater; and/or
the second configuration, the first and second portions are arranged relative to each other such that a/the longitudinal axis of the second portion extends at an angle relative to a/the longitudinal axis of the first portion; and/or
the guide portion is connected to the second portion such that the axis extends in a direction substantially perpendicular to a/the longitudinal axis of the second portion and/or that a/the longitudinal axis of the first portion intersects the axis; and/or
the second portion is configured to receive, mount and/or support a mounting element connected to at least one end of a line; and/or
the first portion is configured to align a mounting element connected to at least one end of a line received in or threaded through the connector, and/or at least one end of a line received in or threaded through the connector relative to the connector; and/or
the first portion comprises a groove and/or a protrusion, the groove and/or protrusion being shaped for mounting and/or supporting a mounting element connected to at least one end of a line received in or threaded through the tensioning arrangement to or on the tensioning arrangement; and/or
the first portion comprises a first connector portion for complementary mating with a corresponding second connector portion, such as of the second part; and/or
the first connector portion is moveably connected or connectable to the second connector portion; and/or
the second connector portion is configured to connect the apparatus to a/the structure; and/or
the transverse axis of the first portion of the first part is substantially perpendicular to an axis of rotation of the guide portion.

31-42. (canceled)

43. A mooring system comprising:
a structure to be moored;
at least one mooring line;
a first end of the mooring line being connected to the structure to be moored by a combined connector and tensioner according to claim 1; and
a second end of the mooring line being connected to an anchoring means.

44. A mooring system as claimed in claim 43, wherein the anchoring means is a Drag Embedment Anchor or a suction pile.

45. A mooring system as claimed in claim 43, wherein the structure is a buoyant or semi-buoyant structure, buoy, floating structure, offshore structure, or floating platform buoy, or the structure is a vessel, such as ship or boat.

46. A mooring system as claimed in claim 43, wherein the at least one mooring line comprises chain, wire or rope.

47. A method of connecting and tensioning a line to a structure, the method comprising:
providing a structure to be moored, a line to be attached to the structure, and a combined connector and tensioner according to claim 1;
connecting the line to the structure by the combined connector and tensioner; and
tensioning the line to the structure by the combined connector and tensioner.

48. (canceled)
